(19) United States
(12) Patent Application Publication
(10) Pub. No.: US 2008/0010508 A1
(43) Pub. Date: Jan. 10, 2008

(54) BACKUP DEVICE

(75) Inventors: Shigeru HIDESAWA, Kawasaki (JP); Kazuhiko Nakamura, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/859,424

(22) Filed: Sep. 21, 2007

Related U.S. Application Data
(63) Continuation of application No. PCT/JP2005/005281, filed on Mar. 23, 2005.

(51) Int. Cl. G06F 11/00

(52) U.S. Cl. 714/7

(57) ABSTRACT

In a backup device, when a piece of software installed on a computer is detected by a detection unit, a transmission unit transmits information for specifying the piece of software. When a reception unit in a server receives this information, a transmission unit acquires from a storage destination information holding unit information about a storage destination in which data is stored, the date being obtained by execution, in the computer, of the piece of software specified by this information, and transmits the information. When a reception unit in the backup device receives this information about a storage destination, a recording control unit records in a recording medium the data stored in the storage destination indicated by this information.

### CROSS REFERENCE TO RELATED APPLICATION

This application is a continuation application of international PCT application No. PCT/JP2005/005281 filed on Mar. 23, 2005.

### BACKGROUND OF THE INVENTION

1. Field of the Invention

The present invention relates to an information processing technology, and particularly to a technique of backing up information.

2. Description of the Related Art

As an example of a technique of backing up information, Japanese Patent Application Publication No. 2002-318730 discloses a technique in which, when a user terminal issues a request to back up information, a center terminal receives information that is the back up target in the user terminal, and backs up the target information to a storage medium.

Also, as another example, Japanese Patent Application Publication No. 2002-132560 discloses a backup system in which a backup device receives via a transmission cable a program stored in a storage device in a terminal device, and stores the received program in a storage device included in the backup system.

Pieces of various data obtained as a result of the execution of pieces of software installed on a computer, such as document data created by execution of word processing software or e-mail data prepared or received as a result of the execution of e-mail software, are stored in storage destinations (storage folders for storing data in the case when memory is managed on the basis of a folder configuration) that are individually defined by respective pieces of software. Accordingly, when a user wants to perform a backup operation for such pieces of various data, he or she has to check such storage destinations for respective pieces of software one by one, which is troublesome. This troublesome operation has to be performed even when the techniques disclosed in the above Patent Documents are used.

Furthermore, storage destinations defined for each piece of software are sometimes changed when, for example, a piece of software is updated to an upgraded version of the same piece of software; accordingly, when a piece of software installed on a computer is updated, the operation of checking the above data storage destinations has to be performed again.

### SUMMARY OF THE INVENTION

The present invention is achieved in view of the above problems, and it is an object of the present invention to eliminate the troublesomeness experienced when performing a backup operation of data obtained by execution of pieces of software on a computer.

A backup device according to one aspect of the present invention is a backup device comprising: a detection unit for detecting a piece of software installed on a computer; a transmission unit for transmitting, to a server, information for specifying the detected piece of software; a reception unit for receiving information about a storage destination in which data is stored, the data being transmitted from the server in response to reception of the information for specifying a piece of software and being obtained by execution of the piece of software in the computer; and a recording control unit for recording in a certain recording medium the data stored in the storage destination.

A server according to another aspect of the present invention is a server comprising: a reception unit for receiving information for specifying a piece of software; a storage destination information holding unit for holding information beforehand, the information being about a storage destination in which data obtained by execution of a piece of software on a computer is stored; and a transmission unit for acquiring, from the storage destination information holding unit, the storage destination information for a piece of software that is specified by the information received by the reception unit, and transmitting the information.

According to the above configurations, data obtained by execution of pieces of software is backed up on the basis of information that is about storage destinations defined for each piece of software. Accordingly, the troublesomeness experienced when performing a backup operation is eliminated.

Further, the present invention also relates to a storage medium for storing a program and allowing a computer read the program, wherein the program causes the computer to function as components of the above backup device and the server according to the present invention.

A backup method according to still another aspect of the present invention is a backup method comprising: detecting a piece of software installed on a computer; transmitting, to a server, information for specifying the detected piece of software; receiving information about a storage destination in which data is stored, the data being transmitted from the server in response to reception of the information for specifying a piece of software and being obtained by execution of the piece of software in the computer; and recording in a recording medium the data stored in the storage destination.

### BRIEF DESCRIPTION OF DRAWINGS

FIG. 1 shows the principle of a backup system that implements the present invention;

FIG. 2 shows a specific configuration of a backup system that implements the present invention;

FIG. 3 shows in detail a configuration of a computer and of a server;

FIG. 4 is a flowchart for a backup process;

FIG. 5 shows an example of data configuration in a management file stored on a HDD;

FIG. 6 shows a flowchart showing process steps of a storage destination information notification process;

FIG. 7 shows an example of a configuration of data in the management file stored on the HDD in the server; and

FIG. 8 shows a recording medium from which a control program can be read by a computer.

### DESCRIPTION OF THE PREFERRED EMBODIMENTS

Hereinafter, embodiments of the present invention are explained by referring to the drawings.

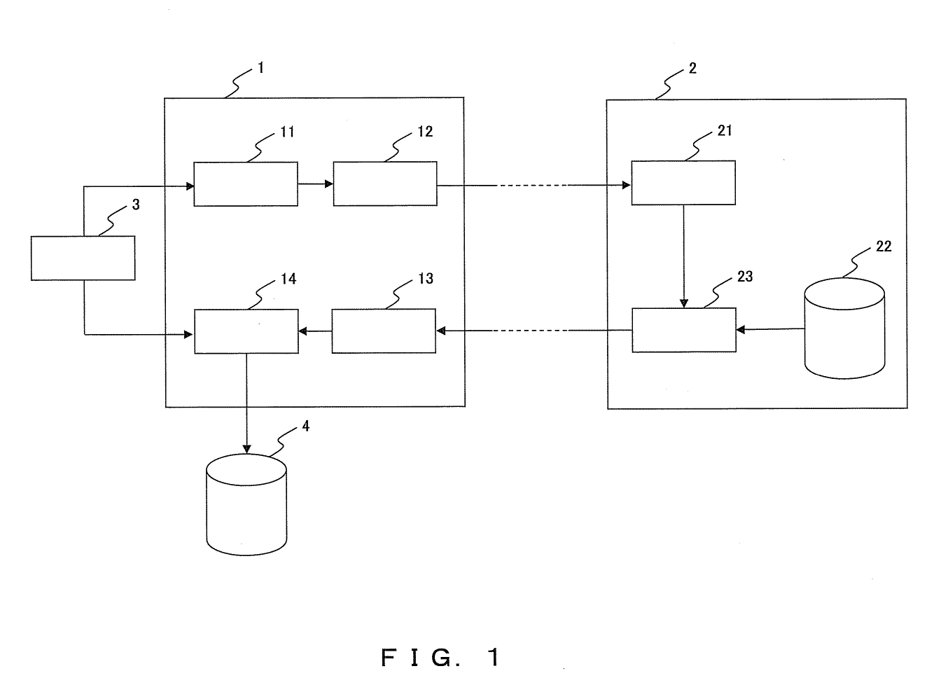

First, FIG. 1 is explained. FIG. 1 shows the principle of a backup system that implements the present invention. In FIG. 1, numeral 1 denotes a backup device, numeral 2 denotes a server, numeral 3 denotes a computer, numeral 4 denotes a recording medium, numeral 11 denotes a detection unit, numeral 12 denotes a backup-device-side transmission unit, numeral 13 denotes a backup-device-side reception unit, numeral 14 denotes a recording control unit, numeral 21 denotes a server-side reception unit, numeral 22 denotes a storage destination information storing unit, and numeral 23 denotes a server-side transmission unit.

The backup device 1 comprises the detection unit 11, the backup-device-side transmission unit 12, the backup-device-side reception unit 13, and the recording control unit 14.

The detection unit 11 detects software installed on the computer 3.

The backup-device-side transmission unit 12 transmits to the server 2 information specifying the pieces of software detected by the detection unit 11.

The backup-device-side reception unit 13 receives data that is transmitted from the server 2 in accordance with reception of the above information specifying pieces of software, and that is information about storage destinations for storing pieces of data obtained by execution of the specified pieces of software in the computer 3.

The recording control unit 14 records in the recording medium 4 data stored in the storage destination specified in the information received by the backup-device-side reception unit 13.

The server 2 comprises the server-side reception unit 21, the storage destination information storing unit 22, and the server-side transmission unit 23.

The server-side reception unit 21 receives information specifying pieces of software, the information being transmitted from the backup device 1.

The storage destination information storing unit 22 beforehand stores information about storage destinations. In the storage destinations, pieces of data obtained by execution of pieces of software in the computer 3 are stored.

The server-side transmission unit 23 acquires, from the storage destination information storing unit 22, information about the above storage destinations specified in the information received by the server-side reception unit 21, and transmits the acquired information.

According to the above configuration, the backup device 1 acquires from the server 2 information about a storage destination for data that is defined for each piece of software, and the data is backed upon the basis of this acquired information, which solves the problem of too much complexity in the backup process.

In the backup device 1 shown in FIG. 1, a configuration can also be employed in which the information for specifying pieces of software installed on the computer 3 includes update information of the pieces of software, and the server-side reception unit 21 receives the information about storage destinations in which pieces of data obtained by execution of the updated pieces of software corresponding to the update information are stored.

According to this configuration, even when pieces of software installed on the computer 3 are updated to upgraded versions, the backup device 1 acquires from the server 2 information about a storage destination for data obtained by the execution of the piece of software, the storage destination being defined for one piece of update information (version information) of each of the pieces of software, and the obtained data is backed up on the basis of this acquired information; accordingly the problem of too much complexity in the backup operations is solved.

Also, it is possible to employ a configuration in which the backup device 1 shown in FIG. 1 comprises a storage destination information holding unit for holding information about a storage destination in which data that is obtained by execution of software in the computer 3 is stored, and the backup-device-side transmission unit 12 causes the computer to transmit information about pieces of software that were detected by the detection unit 11 and whose storage destination information is not held in the storage destination information holding unit.

According to this configuration, only the pieces of storage destination information of the pieces of software that were detected by the detection unit 11 and whose storage destination information is not held in the computer 3 are acquired from the server 2. Thus, the amount of information about storage destinations acquired by the detection unit 11 is much smaller than that in the case when pieces of such information of all the pieces of software detected by the detection unit 11 are to be acquired, which reduces the time taken for the backup operation and processing burdens on the server 2.

Additionally, it is also possible to employ a configuration in which the information that specifies a piece of software installed on the computer 3 includes update information about the piece of software, the backup-device-side transmission unit 12 transmits information about the piece of software that was updated and whose information about the storage destination is not held in the storage destination information holding unit, the backup-device-side reception unit 13 receives information about a storage destination in which data obtained by execution of the updated piece of software in the computer 3 is stored, and the storage destination information holding unit holds the information about the storage destination in which data obtained by the execution of the updated piece of software in the computer 3 is stored.

According to this configuration, even when pieces of software installed on the computer 3 are updated to upgraded versions, the backup device 1 acquires from the server 2 pieces of information about storage destinations for data obtained by the execution of the piece of software; the storage destinations are defined for one piece of update information (version information) of each piece of software and the obtained data is backed up on the basis of this acquired information. Accordingly, the problem of too much complexity in backup operations is solved.

It is also possible to employ a configuration in which the information that specifies a piece of software includes update information about the piece of software, and the server-side transmission unit 23 transmits information about the storage destination in which data obtained by the execution of the updated piece of software is stored.

According to this configuration, even when pieces of software are updated, the server 2 provides to the backup device 1 pieces of information about the storage destinations for pieces of data obtained by the execution of the updated pieces of software, the storage destinations being defined for each of the pieces of update information (version information) of the pieces of software, and the backup process is performed in the backup device 1 on the basis of the provided information; accordingly, the problem of too much complexity in the backup process is solved.

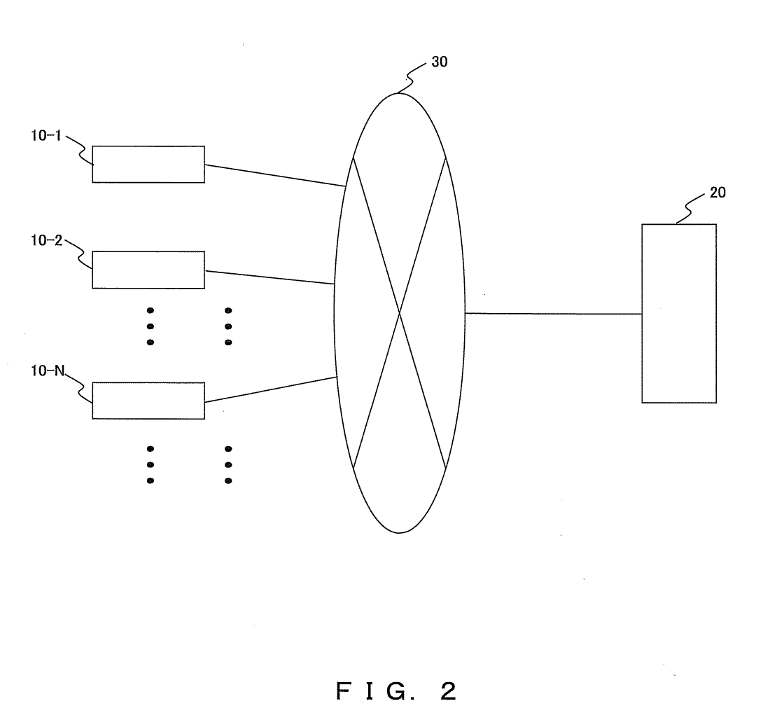

Next, FIG. 2 is explained. FIG. 2 shows a specific configuration of a backup system that implements the present invention.

Numerals 10-1, 10-2, . . . , 10-n denote computers that also function as backup devices. Numeral 20 denotes a server, and numeral 30 denotes a communication network. In other words, the computers 10-1, 10-2, . . . 10-n (referred to as “the computer 10-n” hereinafter) are connected to the server 20 via a communication network 30 such as the Internet. Accordingly, the computer 10-n and the server 20 can transmit and receive data between each other via the communication network 30.

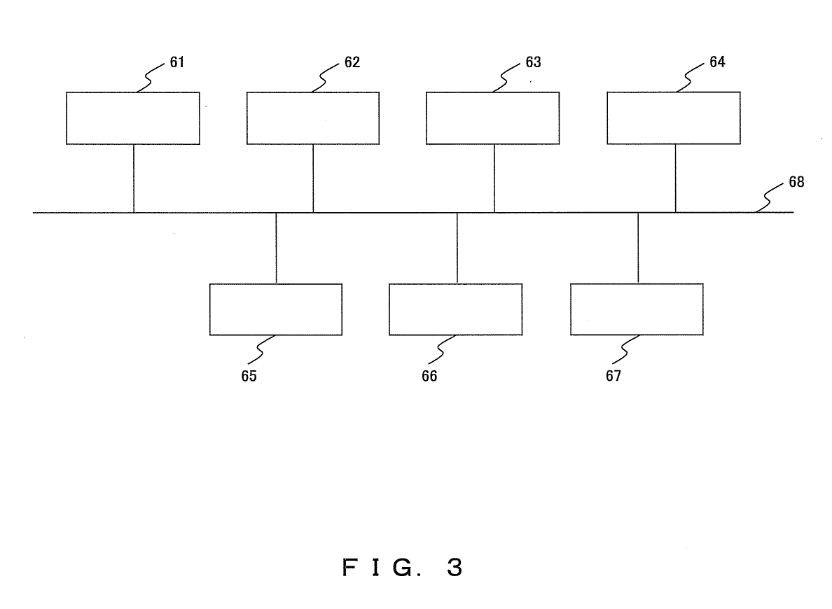

Next, FIG. 3 is explained. FIG. 3 shows in detail the configuration of the computer 10-n and of the server 20. As is understood by referring to FIG. 3, the computer 10-n and the server 20 have the same hardware configuration in the present embodiment.

In FIG. 3, numeral 61 denotes a CPU, numeral 62 denotes a RAM unit, numeral 63 denotes a ROM unit, numeral 64 denotes an HDD, numeral 65 denotes an input unit, numeral 66 denotes an output unit, numeral 67 denotes an interface unit, and numeral 68 denotes a bus. In other words, the CPU 61, the RAM unit 62, the ROM unit 63, the HDD 64, the input unit 65, the output unit 66, and the interface unit 67 are connected to one another via the bus 68, and data is transmitted and received between the RAM unit 62, the ROM unit 63, the HDD 64, the input unit 65, the output unit 66, and the interface unit 67 under the control of CPU 61.

The CPU (Central Processing Unit) 61 is a unit that controls the operations of all the devices shown in FIG. 3.

The RAM (Random Access Memory) unit 62 is used as a memory unit on which the CPU 61 executes various control programs, and is also a main memory unit used as a memory region for temporarily storing various data if necessary.

The ROM (Read Only Memory) unit 63 is a memory unit in which a basic control program executed by the CPU 61 is stored. When the computer is activated, the CPU 61 executes this basic control program, and thereby a basic control on the operations of all the devices in the computer system is performed by the CPU 61.

The HDD (Hard Disk Drive) 64 is a storage device for storing the control program executed by the CPU 61, and is also used for holding data. Also, in the computer 10-n, various programs and data for installed pieces of software are stored.

The input unit 65 receives external information and transfers the received information to the CPU 61. An example of the input unit 65 is an input device for receiving instructions given by users such as a keyboard, a mouse or the like, and the input unit 65 includes if necessary a reading device for transportable storage media such as an FD (Flexible Disk), a CD-ROM (Compact Disc-ROM), a DVD-ROM (Digital Versatile Disc-ROM), an MO (Magneto-Optics) disk, or the like.

The output unit 66 outputs information in accordance with instructions given by the CPU 61, and comprises a display unit such as a CRT (Cathode Ray Tube) device, an LCD (Liquid Crystal Display) device or the like for displaying various data. Further, the output unit 66 comprises a printer for printing various data if necessary. Still further, this output unit 66 comprises a data writing device for writing data to the transportable storage media such as an FD, an MO device, a CD-R, a DVD-R or the like.

The bus 68 connects the devices shown in FIG. 3 to the communication network 30, and controls the communication of data.

As described above, the computer 10-n and the server 20 have a configuration that is well known as a configuration of a computer.

Hereinafter, the backup operation for backing up data obtained as a result of the execution of software installed on the computer 10-n and the backup operation being executed by the backup system shown in FIG. 2, is explained.

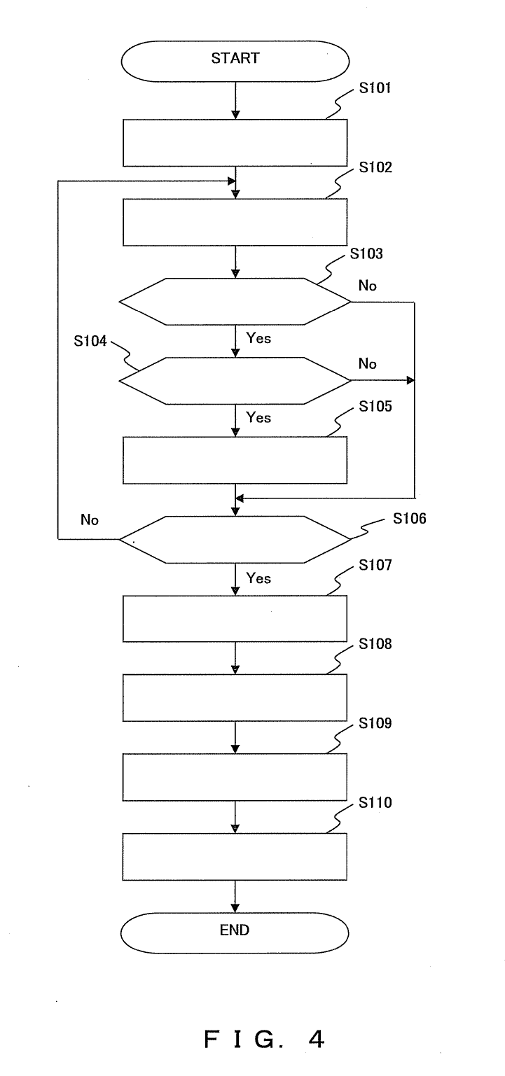

Here, FIG. 4 is explained. FIG. 4 is a flowchart for a backup process performed by the CPU 61 in the computer 10-n. This process is implemented by the CPU 61 reading the control program stored in the HDD 64 and executing the program. This process starts when a user gives the computer 10-n an instruction to execute this process.

In FIG. 4, first, in step S101, data stored on the HDD 64 in the computer 10-n is referred to, all the pieces of software installed on the computer 10-n are detected, and the names (pieces of information for specifying the respective pieces of software) of the pieces of software and the pieces of update information (versions) are acquired.

In S102, one of the names of the pieces of software obtained in step 101 is extracted. In S103, it is determined whether or not the name of the piece of software that was extracted in S102 and that is being executed the most recently is already registered in a management file held in the HDD 64 in the computer 10-n.

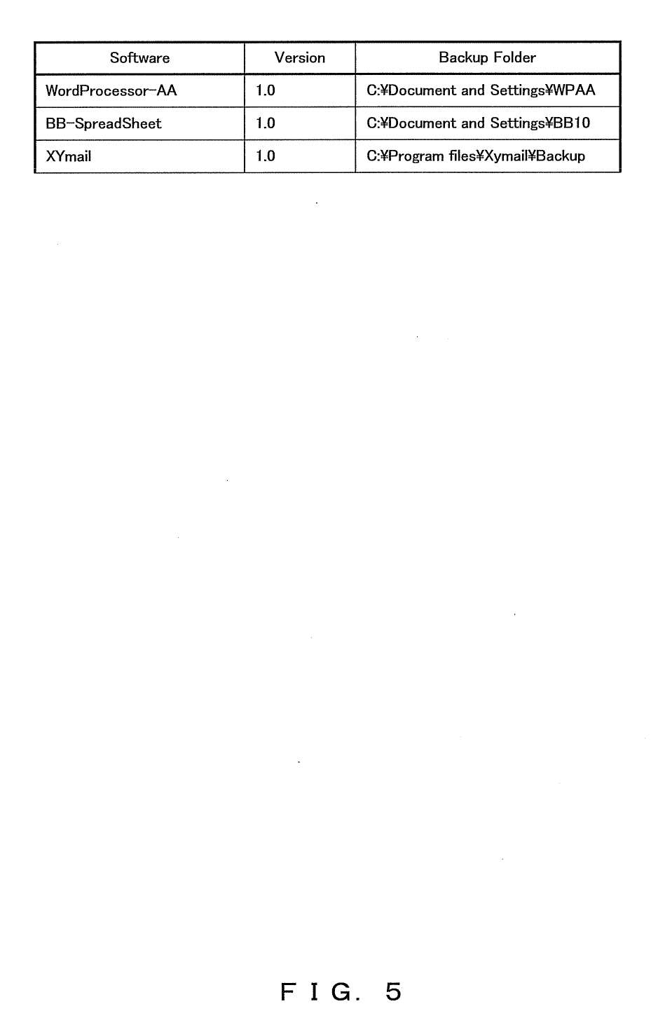

FIG. 5 shows an example of data configuration in this management file.

In the table shown in FIG. 5, the first column (the left column) having the item name “Software” contains names of pieces of software that are installed on the computer 10-n. The second column (the center column) having the item name “Version” contains pieces of version information (update information) respectively of the pieces of software whose names are contained in the first column.

The third column (the right column) having the item name “Backup Folder” contains pieces of information about the locations of storage destinations in which pieces of data that are obtained by execution in the computer 10-n of the pieces of software whose names are contained in the first column are stored. Via this location information, a storage folder is specified in which data is stored when the memory region on the HDD 64 in the computer 10-n is managed in a folder-by-folder configuration. Additionally, this location information is information that was registered in the management file when being transmitted from the server 20, which will be explained in detail later.

By referring to the table in FIG. 5 it can be understood that a piece of software whose name is “WordProcessor-AA” and whose version is currently 1.0 is installed on the computer 10-n, and that data obtained by execution of this piece of software in the computer 10-n is stored in the location “C:¥Document and Settings¥WPAA” in the HDD 64 in the computer 10-n.

By using the management file shown as an example in FIG. 5, it is determined, in S103 in FIG. 4, whether or not the column “Software” contains the name of the piece of software that was extracted in S102. When it is determined that the column “Software” does contain that name (when the determination result is yes), the information about the storage destination for the data of the corresponding piece of software is also held, and accordingly the process proceeds to S104. When it is determined that the column “Software” does not contain that name (when the determination result is no), the information about the storage destination for the data of the corresponding piece of software is thus not held either, and accordingly the process proceeds to S106.

In S104, it is determined whether or not the update information of the piece of software that was extracted in step 102 and that is being executed the most recently is identical to the update information of the corresponding piece of software that is registered in the management file stored in the HDD 64 in the computer 10-n. When it is determined that they are identical to each other (when the determination result is yes) the process proceeds to step 105; when it is determined that they are not identical (when the determination result is no), the process proceeds to S106.

In S105, the piece of software that was extracted in S102 and that is being executed the most recently is removed from the targets of the extraction.

In S106, it is determined whether or not the determination processes of S103 and S104 have been performed on all the pieces of software acquired in S101. When it is determined that the determination processes have already been performed on all the target pieces of software (when the determination result is yes), the process proceeds to S107. When it is determined that there is at least one piece of software on which the determination processes have not been performed (when the determination result is no), the process returns to S102, the names of the pieces of software on which the determination processes have not been performed are extracted, and then the above processes are repeated.

In S107, the interface unit 67 in the computer 10-n receives an instruction to transmit to the server 20 via the communication network the names and update information of the pieces of software that are extracted in S102 (i.e., the pieces of software that were not removed from the extraction targets).

In S108, the interface unit 67 in the computer 10-n receives an instruction to receive information about storage destinations for storing pieces of data that are obtained by execution of pieces of software in the computer 10-n, the information being transmitted in accordance with the reception of the information transmitted from the computer 10-n in S107 from the server 20 via the communication network 30. The operations performed at this moment will be explained later.

In S109, the pieces of information about storage destinations received in S108 are registered, together with the names and pieces of update information of the pieces of software corresponding to the information, on the management file shown in FIG. 5, and are held in the HDD 64 in the computer 10-n. In S110, pieces of data that are obtained by execution of the respective pieces of software installed on the computer 10-n are read from the corresponding storage destinations on the basis of the pieces of information registered in the management file, the read pieces of data are transferred to the output unit 66 in the computer 10-n, the read pieces of data are recorded on a prescribed storage medium, and thereafter this backup process is terminated.

The above process is the backup process, the cup 61 in the computer 10-n performs this backup process, and thereby data obtained by the execution of pieces of software installed on the computer 10-n is backed up.

Next, the operations performed by the server 20, which has received the pieces of information of the names and pieces of update information of software that were transmitted from the computer 10-n in S107, are explained.

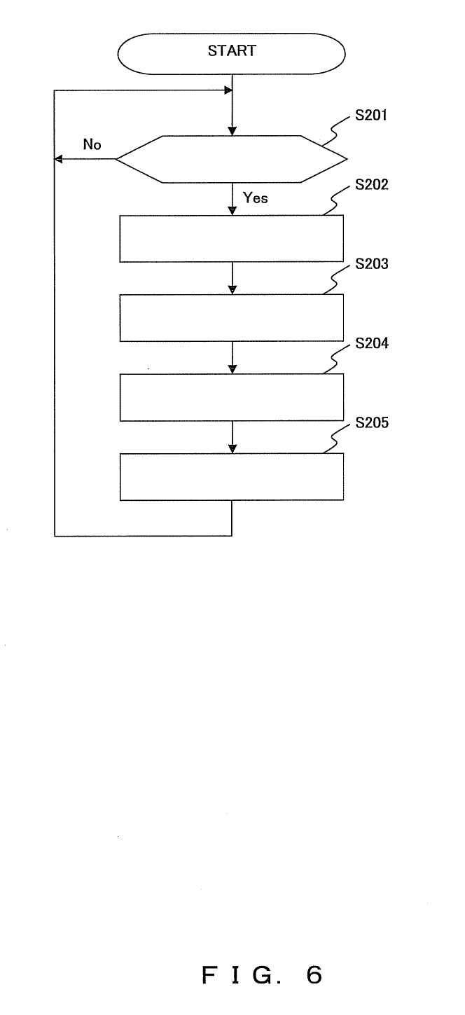

FIG. 6 is explained. FIG. 6 shows a flowchart showing process steps of the storage destination information notification process performed by the CPU 61 in the server 20. This process starts when the server 20 is activated and a prescribed control program is executed.

First, in step 201, it is determined whether or not the interface unit 67 in the server 20 has received the pieces of information of the names and pieces of update information of software that were transmitted from the computer 10-n, and this step 201 is repeated until the interface unit 67 receives these pieces of information (until the determination result becomes yes).

In S202, these pieces of information that were received by the interface unit 67 in the server 20 are acquired. Then, in S203, the management file held in the HDD 64 in the server 20 is referred to. Then, in S204, the information about storage destinations that corresponds to the information received in S202 is acquired from the management file.

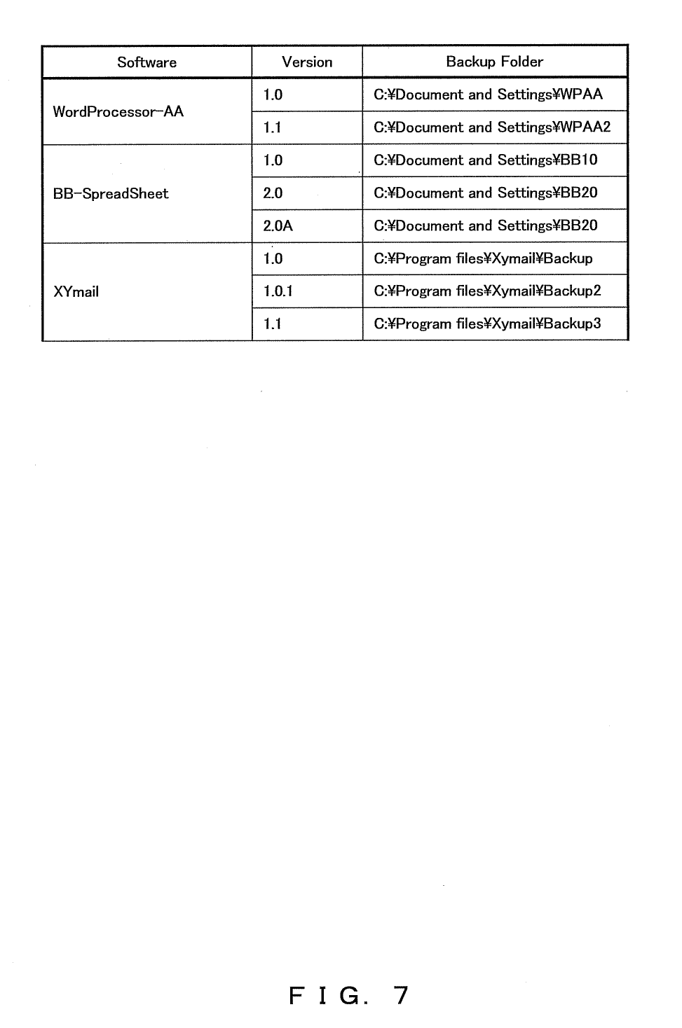

FIG. 7 shows an example of a configuration of data in the above management file.

In the table shown in FIG. 7, the first column (the left column) having the item name “Software” contains names of pieces of software that are installed on the computer 10-n. The second column (the center column) having the item name “Version” contains pieces of version information (update information) respectively of the pieces of software whose names are contained in the first column.

The third column (the right column) having the item name “Backup Folder” contains pieces of location information about storage destinations in which are stored pieces of data that are obtained by execution, in the computer 10-n, of the pieces of software whose names are contained in the first column. Via this location information, a storage folder is specified in which data is stored when the memory region on the HDD 64 in the computer 10-n is managed in a folder-by-folder configuration. Additionally, in many cases, these pieces of information are provided by the companies that produced the respective pieces of software, and are stored in the HDD 64 in the server 20. However, it is also possible for these pieces of information to be retrieved by the manager of the server 20 in order to be stored in the HDD 64 in the server 20.

In the above table shown in FIG. 7, one piece of information about the storage destination is assigned to each of the versions of one and the same piece of software because the storage destination of one and the same piece of software can change depending upon the version of the piece of software.

Again, FIG. 6 is explained. In S205, the interface unit 67 in the computer 10-n receives an instruction to transmit to the server 20 via the communication network 30 the pieces of information about the storage destinations acquired in S204. Thereafter, the process returns to step 201, and the reception of the information transmitted from the computer 10-n is repeated.

The above process is the storage destination information notification process. Via this process executed by the CPU 61 in the server 20, pieces of information about the storage destinations for pieces of data that are obtained by execution of pieces of software in the computer 10-n are transmitted from the server 2 to the communication network 30 in accordance with the reception of pieces of information about the names and updates of the pieces of software that were transmitted from the computer 10-n.

It is also possible to employ a configuration in which a control program causing a computer to execute the respective processes shown in FIGS. 4 and 5 that are executed by the computer 10-n or CPU 61 in the above described embodiments is recorded in a computer readable recording medium and is read by a computer from the recording medium in order to be executed for implementing the present invention.

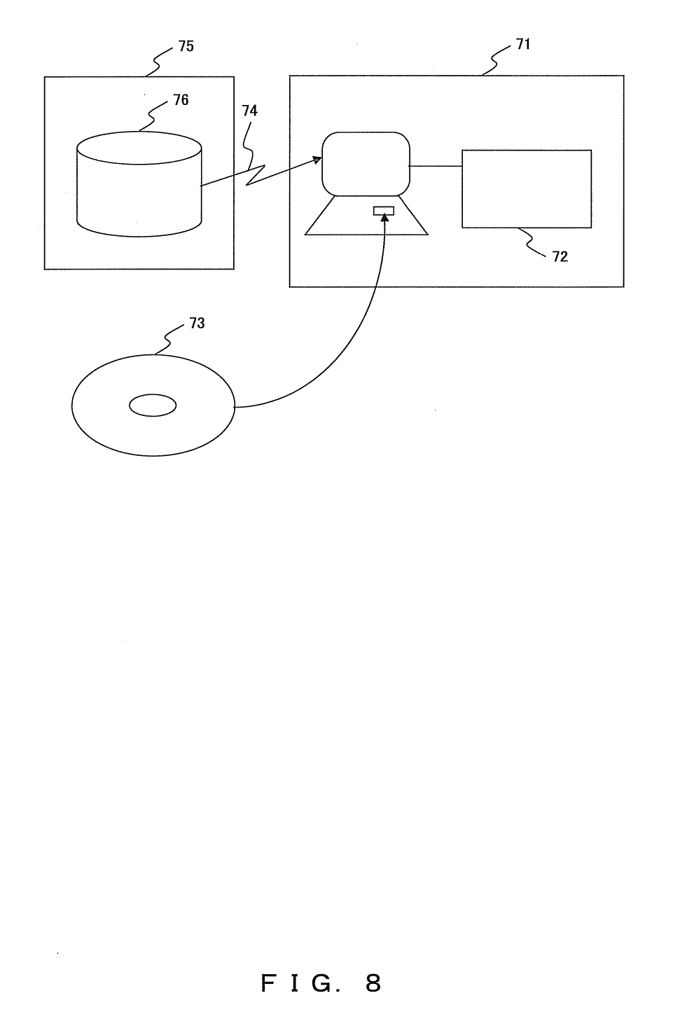

An example of the storage medium from which a computer can read the control program is shown in FIG. 8. As shown in FIG. 8, as the above recording medium, a memory unit 72 such as a RAM unit, a ROM unit, or a hard disk device that are either included in a computer 71 or are external devices for the computer 71, or a transportable recording medium 73 such as a flexible disk, MO (Magneto-Optics) disk, CD-ROM, or DVD-ROM can be used.

It is also possible to employ a configuration in which the recording medium is a storage device 76 that is included in a computer that is connected to the computer 71 via a communication line 74 and that functions as a program server. In this case, transmission signals that are obtained by modulating carrier waves in accordance with the data signals that express the control program are transmitted from a program server 75 via a communication line 74 serving as a transmission medium, and the computer 71 reproduces the control program by demodulating the received transmission signals in order to execute this control program.

Additionally, the present invention allows various alterations and modifications without departing from the spirit of the present invention.

What is claimed is:

1. A backup device comprising:
a detection unit for detecting a piece of software installed on a computer;
a transmission unit for transmitting, to a server, information for specifying the detected piece of software;
a reception unit for receiving information about a storage destination in which data is stored, the data being transmitted from the server in response to reception of the information for specifying a piece of software and being obtained by execution of the piece of software in the computer; and
a recording control unit for recording in a recording medium the data stored in the storage destination.

2. A storage medium for storing a program and allowing a computer read the program, wherein the program causes the computer to execute:
a detection process of detecting a piece of software installed on the computer;
a transmission process of transmitting, to a server, information for specifying the detected piece of software;
a reception process of receiving information about a storage destination in which data is stored, the data being transmitted from the server in response to reception of the information for specifying a piece of software and being obtained by execution of the piece of software in the computer; and
a recording control process of recording in a recording medium the data stored in the storage destination.

3. The storage medium according to claim 2, wherein:
the information for specifying a piece of software includes update information about the piece of software; and
the reception process causes the computer to receive information about a storage destination in which data is stored, the data being obtained by execution of the piece of software that was subject to an update corresponding to the update information.

4. The storage medium according to claim 2, wherein the program causes the computer to further execute:
a storage destination information holding process of holding the information about a storage destination in which data is stored, the data being obtained by execution of the piece of software, wherein:
the transmission process causes the computer to transmit information about a piece of software, from among the detected pieces of software, whose information about a storage destination is not stored by the storage destination information holding process.

5. The storage medium according to claim 4, wherein:
the information for specifying a piece of software includes update information about the piece of software;
the transmission process causes the computer to transmit information about a piece of software, from among the pieces of software that were subject to updates corresponding to the update information, whose information about their storage destination is not held by the storage destination information holding process;
the reception process causes the computer to receive information about a storage destination in which data is stored, the data being obtained by execution of the piece of software that was subject to an update corresponding to the update information; and
the storage destination information holding process causes the computer to hold information about a storage destination in which data is stored, the data being obtained by execution of the piece of software that was subject to an update corresponding to the update information.

6. A server comprising:
a reception unit for receiving information for specifying a piece of software;
a storage destination information holding unit for holding information beforehand, the information being about a storage destination in which data obtained by execution of a piece of software on a computer is stored; and
a transmission unit for acquiring, from the storage destination information holding unit, the storage destination information for a piece of software that is specified by the information received by the reception unit, and transmitting the information.

7. A storage medium for storing a program and allowing a computer read the program, wherein the program causes the computer to execute:
a reception process of receiving information for specifying a piece of software; and
a transmission process of transmitting information about a storage destination in which data is stored, the data being obtained by execution of a piece of software that is specified by the information.

8. The storage medium according to claim 7, wherein:
the information for specifying a piece of software includes update information about the piece of software; and
the transmission process causes the computer to transmit information about a storage destination in which data is stored, the data being obtained by execution of the piece of software that was subject to an update corresponding to the update information.

9. A backup method comprising:
detecting a piece of software installed on a computer;
transmitting, to a server, information for specifying the detected piece of software;
receiving information about a storage destination in which data is stored, the data being transmitted from the server in response to reception of the information for specifying a piece of software and being obtained by execution of the piece of software in the computer; and
recording in a recording medium the data stored in the storage destination.
